(19) United States
(12) Patent Application Publication
(10) Pub. No.: US 2014/0321541 A1
(43) Pub. Date: Oct. 30, 2014

(54) METHOD AND APPARATUS FOR CAPTURING AN IMAGE

(71) Applicant: MOTOROLA SOLUTIONS, INC., Schaumburg, IL (US)

(72) Inventors: DAVID E. KLEIN, DAVIE, FL (US); TYRONE D. BEKIARES, PARK RIDGE, IL (US); KEVIN J. O'CONNEL, PALATINE, IL (US)

(73) Assignee: MOTOROLA SOLUTIONS, INC., Schaumburg, IL (US)

(21) Appl. No.: 13/873,928

(22) Filed: Apr. 30, 2013

(51) Int. Cl. H04N 19/20; H04N 19/593

(52) U.S. Cl. CPC H04N 19/00387; H04N 19/00763
USPC 375/240.08

(57) ABSTRACT

A method and apparatus are provided for capturing video so that compression and quality can be optimized. During operation, a video recording system will employ a learning algorithm to determine periods when a light bar is on, or active. Reference Intra frames are then stored and used for the subsequent creation of predictive frames. More particularly, at least a first Intra frame is stored and used for creating predictive frames during periods of light bar activity. In a similar manner, a second Intra frame is stored and used for creating predictive frames during periods of light bar inactivity. By learning the light bar pattern, Intra frames can be more intelligently selected, resulting in optimized compression and quality.

### FIELD OF THE INVENTION

The present invention relates generally to video capture and in particular to a method and apparatus for capturing an image that optimizes compression and quality.

### BACKGROUND OF THE INVENTION

Modern video codecs employ two basic techniques for encoding source video, spatial texture coding and temporal motion compensation. In either case, the source video is first divided into a sequence of frames each having a mesh of macroblocks. When all of the macroblocks within a frame are encoded using texture coding techniques, the frame is called an Intra, “I”, “reference”, or “IDR” frame, wherein the decoding of the frame does not depend upon the successful decoding of one or more previous frames. Texture coding is a means of compressing pixel data from a source video frame, typically using Discrete Cosine Transformations. When some or all of the macroblocks within a frame are encoded using temporal coding techniques, the frame is called a Predictive, Inter, or “P” frame, wherein the decoding of the frame depends upon the successful decode of one or more previous frames, starting with an Intra frame as a reference. Temporal coding is a means of describing the movement of compressed pixel data from one source frame to another, typically using motion compensation. Examples of encoding algorithms include, but are not limited to, standard video compression technologies like MPEG-2, MPEG-4, H.263, VC-1, VP8, H.264, H.EVC, etc.

Modern video codecs achieve their incredible compression ratios largely through predictive encoding. However, the drawback is that packet loss (and the accompanying loss of texture and/or motion data) within video frames upon which future frames are predicted causes a propagation of spatial errors or deformities, in time, until that spatial area is refreshed in a non-predictive manner via the next Intra frame in the sequence. Therefore, to limit error propagation, Intra frames are injected into the video stream at regular intervals (e.g. every 1 or 2 seconds). Historically, the last Intra frame transmitted served as the starting reference for subsequent predictive frames. Modern video compression technologies, such as H.264 and H.EVC, however, permit the selection of one of several stored Intra frames to serve as a reference for subsequent predictive frames.

Cameras using the above techniques are often used by public safety practitioners to record specifics of accident and crime scenes in an unaltered state for evidentiary purposes. The video recorded can be used to objectively determine actual circumstances of critical events such as officer-involved shootings and to investigate allegations of police brutality or other crimes/criminal intent. A common use case entails an officer responding to an incident by activating the light bar on their vehicle and initiating recording of a vehicle-mounted video camera. Typically, the light bar on the responding officer's vehicle will flash patterns of blue, red, white, and/or amber light once activated.

When a video camera is operated near the illumination of light bars, the video quality and compression may suffer. This is particularly true when a transition in the state of the light bar occurs in between Intra frames. For example, if an Intra frame was captured when the light bar was off, any subsequent predictive frame (which use the captured Intra frame as a reference) encoded when the light bar is on may require excessive texture encoding, resulting in a high data rate and/or poor image quality. Therefore, a need exists for a method and apparatus for capturing video that results in optimized compression and quality.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates a system for collection and storing video.

FIG. 2 is a block diagram showing the computer of FIG. 1.

FIG. 3 is a flow chart showing operation of the system of FIG. 1.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to alleviate the aforementioned need, a method and apparatus are provided for capturing video so that compression and quality can be optimized. During operation, a video recording system will employ a learning algorithm to determine periods when a light bar is on, or active. Reference Intra frames are then stored for various light bar states and used for the subsequent creation of predictive frames. More particularly, at least a first Intra frame is stored and used as a reference for predictive frames during periods of light bar activity. In a similar manner, a second Intra frame is stored and used as a reference for predictive frames during periods of light bar inactivity. By learning the light bar pattern, Intra frames can be more intelligently selected as a reference for predictive encoding, resulting in optimized compression and quality.

Expanding on the above, in actuality there may be multiple light sources strobed from any particular light bar. Instead of simply having a first Intra frame used when the light bar is activated, there may exist an Intra frame that is used for each color strobed, or several Intra frames matching a mix of colors due to multiple color strobes active at once. With the strobe pattern learned, the system can proactively choose reference frames (Intra frames). For example, if the light bar is in the middle of the ‘red’ strobe sequence, the last ‘red’ Intra frame is selected as a reference.

In the absence of the present invention, an encoder would have to select an appropriate reference frame through computationally expensive pixel comparison operations between the captured frame and the N candidate reference frames. Furthermore, this ‘best effort’ method of reference frame selection is prone to error (i.e., not selecting the appropriate reference frame given the current state of the light bar).

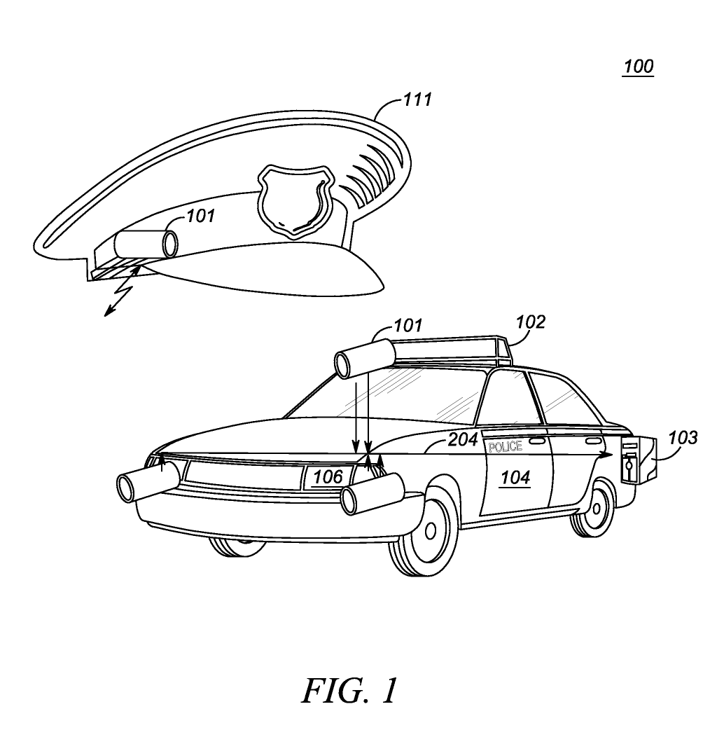

Turning now to the drawings, where like numerals designate like components, FIG. 1 illustrates system 100 for collection and storing of video. As shown, system 100 comprises a plurality of cameras 101. In one embodiment one or more of the cameras are mounted upon a guidable/remotely positionable camera mounting. System 100 may also utilize a wearable camera 101 that may be located, for example, on an officer's hat 111. Computer 103 comprises a simple computer that serves to control camera mounts, vehicle rooftop light bar 102, headlights 106, and/or other vehicle peripheral equipment. Computer 103 also receives, encodes, and stores video from cameras 101. Computer 103 is usually housed in the trunk of the vehicle 104. Vehicle 104 preferably comprises a public safety, service, or utility vehicle.

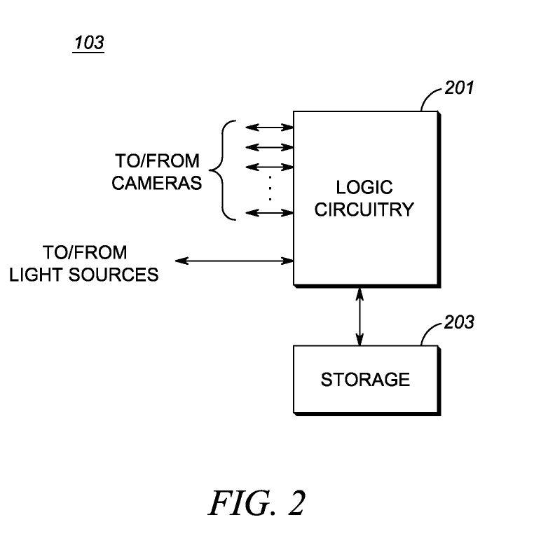

FIG. 2 is a block diagram showing the computer of FIG. 1. It should be noted that the components and functionality described below could easily be incorporated into any camera. More particularly, instead of having computer 103 selecting Intra frames as described above, this functionality may be inserted into any camera that is performing on-board encoding of video.

As shown, computer 103 comprises logic circuitry 201. Logic circuitry 201 comprises a digital signal processor (DSP), general purpose microprocessor, a programmable logic device, or application specific integrated circuit (ASIC) and is utilized to accesses and control light sources 102 and 106 and cameras 101. Storage 203 comprises standard random access memory and/or non volatile storage medias like SSD or HDD and is used to store/record video received from cameras 101.

During operation logic circuitry 201 receives a recording event and instructs cameras 101 to start video recording. The recording event may simply comprise instructions received from a user through a graphical user interface (GUI) (GUI not shown in FIG. 2). Alternatively, the recording event may simply comprise an indication that a camera has been activated to record video. Regardless of the makeup of the recording event, in response to the event, logic circuitry 201 determines when light bar 102 is active. During periods of activity, Intra frames will be produced and stored in storage 203. Likewise, during periods of inactivity, Intra frames will be produced and stored in storage 203. Logic circuitry 201 will then encode video from cameras 101 using an appropriate Intra frame. More particularly, at future time periods, logic circuitry 201 will determine a time period when the frame was acquired and determine whether or not light bar 102 was active or inactive during the acquisition of a particular frame. Based on whether or not light bar 102 was active or inactive, an appropriate Intra frame will be selected as a reference for subsequent predictive frames during encoding.

As discussed above, there may be several colors (e.g., red, blue, and white) strobed from light bar 102. Thus, there may exist an Intra frame for use when the light bar is off, and there may exist several Intra frames for use when different colors are strobed. All Intra frames used will be based on the predicted light bar pattern of strobed colors.

### Determining a Light Bar Strobe Pattern

In a first embodiment, the control of light bar 102 takes place with computer 103 sending instructions to program light bar 102. If the instructions are detailed enough, computer 103 learns the light bar pattern by determining how light bar 102 was programmed. “Drift” may occur between the prediction and the actual strobing of light bar 102. When this occurs, an inappropriate Intra frame may be used. This will result in excessive texture encoding in predictive frames, resulting in an excessively high bit rate and/or poor video quality. When an encoding or quality threshold is reached (i.e., when an amount of texture encoding is greater than a threshold or the image quality is below a threshold), logic circuitry 201 may simply re-program light bar 102, basing all future determinations of light bar activity on the reprogrammed light bar's strobing pattern.

In an alternate embodiment, light bar 102 is simply activated by computer 103 in a binary fashion by either turning it on or off. Detailed programming of light bar 102 does not occur. In this scenario, logic circuitry 201 will determine the light bar pattern by utilization of typical video encoding during the learning sequence where the different reference Intra frames are generated and the chromium and luminance values in the color histogram allow for the identification of the pattern during the learning sequence. Thus, the chromium and luminance values of each acquired frame will be analyzed to determine if the light bar is active. Once a pattern is identified, the Intra frame references are associated with a given time cycle with a first Intra frame being chosen when the light bar is determined to be inactive and at least a second Intra frame being chosen when the light bar is determined to be active. Additional logic can be utilized such that the Intra frame determination is also augmented by a histogram verification such that real time adjustments can be made without initiating a new learning sequence. This algorithm does not preclude additional triggers associated with dramatic changes to the histogram due to multiple light strobes arriving at a scene such that a full learning sequence would occur to optimize the Intra frame references with the different timing and potentially different strobe colors or mix of colors.

### The Acquisition of New Intra Frames

Periodically, new Intra frames will need to be produced. This may happen on a regular basis (e.g., once every 30 frames), or may happen when excessive texture encoding would need to take place to produce a predictive frame (e.g., a scene change). New Intra frames are generated via excessive motion detection or via the analysis of the luminance or chromium changes in the image. This last change is typically determined from the color histogram, which is a relatively simple computational creation. Specifically, the histogram can be dramatically altered by white balance, contrast, brightness, saturation, and color space. The changing state of the light bars will drive change in the histogram and allow the encoding algorithm to identify a match to existing Intra frames or the need for the creation of a new reference Intra frame.

The operation of the system of FIG. 1 takes place by logic circuitry 201 learning a strobe pattern for a light source. As discussed above, the learning comprises determining when the light source will be active. The logic circuitry 201 creates and stores (in storage 203) Intra frames for use when the light source is active and creates and stores Intra frames for use when the light source is inactive. A particular Intra frame is chosen by logic circuitry 201 from a plurality of possible Intra frames based on the determined strobe pattern for the light source and logic circuitry 201 encodes video utilizing the chosen Intra frame for encoding subsequent predictive frames.

As discussed above the light source may comprise a light bar on a public safety vehicle that repeatedly strobes multiple colors at regular time intervals and the step of determining the pattern comprises the step of determining the occurrence of a particular color at a particular time. These multiple colors may comprise colors from the group consisting of red, blue, white, and the like.

As is evident, there may exist a situation where an Intra frame is used to create the predictive frames, even though it is older than a recently-created Intra frame. For example, if the light bar is currently strobing red, the “red” Intra frame will be chosen for creating predictive frames, even though a “white” Intra frame may be newer. Therefore, the plurality of possible Intra frames may comprise a newest Intra frame and an older Intra frame, and the step of choosing the Intra frame may comprise the step of choosing the older Intra frame from the plurality of possible Intra frames.

As discussed above, the step of “learning” may simply comprise sending programming instructions to the light source and learning the strobe pattern from the programming instructions sent to the light source. Alternatively, the step of “learning” may comprise identifying time periods for a repeating pattern of color and luminance values within a histogram.

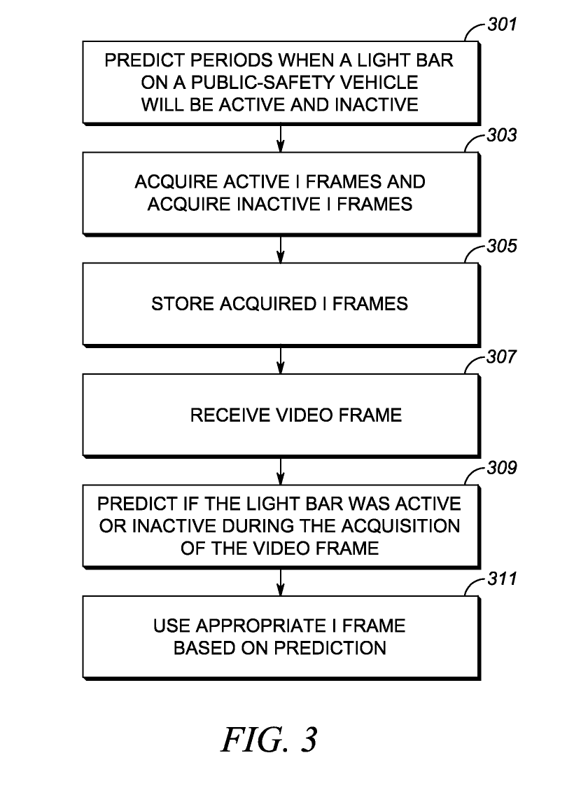

FIG. 3 is a flow chart showing the operation of public safety vehicle 104 of FIG. 1. Public safety vehicle 104 comprises light bar 102, computer 103 determining periods when a light bar on a public safety vehicle will be active, and determining periods when the light bar on the public safety vehicle will be inactive, camera 101, and storage 203 for storing the active and inactive Intra frames for future encoding of video.

The logic flow begins at step 301 where computer 103 determines periods when a light bar on a public safety vehicle will be active and determines periods when the light bar on the public safety vehicle will be inactive. Computer 103 then acquires “active” Intra frames for encoding during a determined period of light bar activity and ‘inactive” Intra frames for encoding video during a determined period of light bar inactivity (step 303). At step 305 the active and inactive Intra frames are stored for future encoding of video.

A video frame is received by computer 103 at step 307 and at step 309 the computer determines if the light bar was active or inactive during the acquisition of the video frame. Computer 103 will then use the stored active Intra frame or the stored inactive Intra frame for encoding the video frame based on the determination if the light bar was active or inactive during the acquisition of the video frame (step 311).

As discussed above, the stored active and inactive Intra frames comprise a newest Intra frame and an older Intra frame, and the step of using the stored active Intra frame or stored inactive Intra frame may comprise the step of using the older Intra frame from the plurality of stored Intra frames. Additionally, the step of determining periods when the light bar on the public safety vehicle will be active, and the step of determining periods when the light bar on the public safety vehicle will be inactive may comprise the step of the computer determining based on a chromium and luminance value in a color histogram.

As discussed above, the computer may determine that the encoded video frame required an amount of texture encoding greater than a threshold and again determine periods when the light bar on the public safety vehicle will be active and again determine periods when the light bar on the public safety vehicle will be inactive.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising the steps of:
learning a strobe pattern for a light source;
choosing an Intra frame from a plurality of possible Intra frames based on the strobe pattern for the light source; and
encoding video utilizing the chosen Intra frame as a reference for encoding subsequent predictive frames.

2. The method of claim 1 further comprising the steps of:
creating and storing Intra frames for use when the light source is active; and
creating and storing Intra frames for use when the light source is inactive.

3. The method of claim 1 wherein the step of learning the strobe pattern for the light source comprises the step of determining when the light source will be active.

4. The method of claim 3 wherein:
the light source reputedly strobes multiple colors at predictable times; and
the step of determining comprises the step of determining the occurrence of a particular color at a particular time.

5. The method of claim 4 wherein the multiple colors comprises colors from the group consisting of red, blue, white, and amber.

6. The method of claim 1 wherein the light source comprises a light bar on a public safety or public service/utility vehicle.

7. The method of claim 1 wherein the plurality of possible Intra frames comprises a newest Intra frame and an older Intra frame, and wherein the step of choosing the Intra frame comprises the step of choosing the older Intra frame from the plurality of possible Intra frames.

8. The method of claim 1 wherein the step of learning comprises the steps of:
sending programming instructions to the light source; and
learning the strobe pattern from the programming instructions sent to the light source.

9. The method of claim 1 wherein the step of learning comprises the steps of:
identifying a repeating pattern of color and luminance values within a histogram.

10. A method for encoding video, the method comprises the steps of:
determining periods when a light bar on a public safety vehicle will be active;
determining periods when the light bar on the public safety vehicle will be inactive;
acquiring “active” Intra frames for encoding during a determined period of light bar activity;
acquiring ‘inactive” Intra frames for encoding video during a determined period of light bar inactivity;
storing the active and inactive Intra frames for future encoding of video;
receiving a video frame for encoding;
determining if the light bar was active or inactive during the acquisition of the video frame; and
using the stored active Intra frame or the stored inactive Intra frame for encoding the video frame based on the determination if the light bar was active or inactive during the acquisition of the video frame.

11. The method of claim 10 wherein the stored active and inactive Intra frames comprise a newest Intra frame and an older Intra frame, and wherein the step of using the stored active Intra frame or stored inactive Intra frame comprises the step of using the older Intra frame from the plurality of stored Intra frames.

12. The method of claim 10 wherein the step of determining periods when the light bar on the public safety vehicle will be active, and the step of determining periods when the light bar on the public safety vehicle will be inactive comprises the step of determining based on a chromium and luminance value in a color histogram.

13. The method of claim 10 further comprising the steps of:
determining that the encoded video frame required an amount of texture encoding greater than a threshold; and
again determining periods when the light bar on the public safety vehicle will be active;
again determining periods when the light bar on the public safety vehicle will be inactive.

14. A public safety vehicle comprising:
a light bar;
a computer determining periods when a light bar on a public safety vehicle will be active, and determining periods when the light bar on the public safety vehicle will be inactive;
a camera;
wherein the computer acquiring from the camera “active” Intra frames for encoding during a determined period of light bar activity and acquiring “inactive” Intra frames for encoding video during a determined period of light bar inactivity;
storage storing the active and inactive Intra frames for future encoding of video;
wherein the computer receives a video frame from the camera, determines if the light bar was active or inactive during the acquisition of the video frame, and uses the stored active Intra frame or the stored inactive Intra frame for encoding the video frame based on the determination if the light bar was active or inactive during the acquisition of the video frame.

15. The public safety vehicle of claim 14 wherein the storage comprises a newest Intra frame and an older Intra frame, and wherein the computer uses the older Intra frame from the plurality of stored Intra frames for encoding the video frame.

16. The public safety vehicle of claim 15 wherein the computer determines based on a chromium and luminance value in a color histogram.

17. The public safety vehicle of claim 14 wherein the computer, based on an amount of texture encoding being above a threshold, will again determine periods when the light bar on the public safety vehicle will be active and inactive
